(19) United States
(12) Patent Application Publication
(10) Pub. No.: US 2016/0224316 A1
(43) Pub. Date: Aug. 4, 2016

(54) VEHICLE INTERFACE STSTEM

(71) Applicant: JAGUAR LAND ROVER LIMITED, Coventry, Warwickshire (GB)

(72) Inventor: Christopher Mitchell, Coventry, Warwickshire (GB)

(21) Appl. No.: 14/917,813

(22) PCT Filed: Aug. 20, 2014
(86) PCT No.: PCT/EP2014/067745

§ 371 Date: Mar. 9, 2016

(30) Foreign Application Priority Data
Sep. 10, 2013 (GB) 1316074.2

(51) Int. Cl. G06F 3/16; G10L 15/26; G06F 17/21

(52) U.S. Cl. CPC G06F 3/167; G06F 17/212; G10L 15/265; G10L 2015/223

(57) ABSTRACT

The present invention relates to a vehicle interface system (1) for performing word processing. The system (1) includes a display (13) for displaying text in the form of words made up of one or more characters. A text display location (15) is provided in said display, the text display location (15) consisting of a fixed number of character entry points (C). The system (1) also includes a processor (5) configured to divide a passage of text into segments (S) made up of one or more words. The segments (S) each consist of a maximum number of characters equal to or less than the fixed number of said character entry points (C). The processor (5) is configured to output each complete segment (S) of said text to the display (13) for display in said text display location (15). The invention also relates to a method of operating a vehicle interface system (1); and a vehicle (3) including the vehicle inter face system (1).

### TECHNICAL FIELD

The present invention relates to a vehicle interface system and particularly, but not exclusively, to a vehicle interface system for performing word processing; a method of operating a vehicle interface system to perform word processing; a vehicle; and a computer program product.

### BACKGROUND OF THE INVENTION

It is widely appreciated that people are becoming increasingly connected through technology and the use of messaging interfaces, such as short messaging service (SMS) and email, is increasingly prevalent. However, the problem of distraction arises when a person tries to send a message using a nomadic device whilst performing other tasks, notably driving. The use of such devices whilst driving has been outlawed in several jurisdictions.

The inventor(s) recognise that an interface system which provides text processing functions whilst reducing or minimising the cognitive load on the user would have wide ranging applications, particularly in vehicles.

At least in certain embodiments, the present invention seeks to ameliorate or overcome at least some of the shortcomings associated with known systems.

### SUMMARY OF THE INVENTION

Aspects of the present invention relate to a vehicle interface system for performing word processing; a method of operating a vehicle interface system to perform word processing; a vehicle; and a computer program product.

According to an aspect of the present invention there is provided a vehicle interface system for performing word processing, the system comprising:
a display for displaying text in the form of words made up of one or more characters, the display comprising a text display location consisting of a fixed number of character entry points;
a processor configured to:
   divide a passage of text into segments comprising one or more words, each segment consisting of a maximum number of characters equal to or less than the fixed number of said character entry points; and
   output each complete segment of said text to the display for display in said text display location.

The vehicle interface system outputs each complete segment of the passage of text to enable a user to check its content and accuracy. The display of restricted sections of the passage of text can help to reduce the time period over which the user looks at the display, thereby reducing potential distractions within the vehicle.

The vehicle interface system can be configured to receive an audio signal from a microphone disposed in the vehicle cabin. The audio signal can convey a voice signal from a user. In use, the voice signal can be generated when the user dictates a message and converted into text data using speech recognition techniques.

The vehicle interface system can comprise a wireless transmitter operative to transmit the voice signal to a remote speech processing station (such as a remote server) for converting the voice signal into text data corresponding to the passage of text. The vehicle interface system can comprise a wireless receiver operative to receive said text data from the remote processor. In use, the text data can be generated remotely at said remote speech processing station and transmitted to the vehicle interface system.

Alternatively, the vehicle interface system can comprise a speech processing module for converting the voice signal into text data corresponding to said passage of text. The text data then forms the text to be output to the display. The speech recognition can be performed directly by the speech processing module on-board the vehicle. The processor could incorporate the speech processing module. Alternatively, the speech processing module could comprise a separate processor.

The vehicle interface system could be configured to provide the text processing functions described herein on text derived from other sources. The passage of text could, for example, be received in a text document, such as an SMS message or an email.

The processor could be arranged to form each complete segment from a fixed number of characters, for example utilising hyphens to split words between segments. Alternatively, the processor can be configured to form each segment from complete words.

The processor can be configured to divide the text into said segments as the text is input. Alternatively, the processor can be configured to divide the text into said segments after the text has been input. For example, a user can dictate a passage which is converted into a block of text which is subsequently divided into said segments.

In systems utilising a remote server to perform speech recognition function, the subdivision of the text into segments could optionally be performed by the remote server. For example, the text could be returned to the vehicle interface system already divided into said segments.

The processor can be configured to output said segments to the display for output to said text display location. The processor can be configured to output said segments to said text display location sequentially.

The processor can be configured to perform editing only in respect of the text which is displayed in the text display location. In this arrangement, only the text in the current displayed segment is edited. Thus, a command which can be applied to text contained in multiple segments (for example to select a particular word or phrase used several times in the dictation) is applied only to the segment in the text display location.

The processor can be configured to perform editing of said text in response to one or more voice commands.

The processor can be configured to convert the passage of text to an audio signal for output to a user. The processor can, for example, form a Text-To-Speech (TTS) function to read the converted text to the user. The TTS function could be performed by the remote server and a corresponding electronic signal received by the processor for audio output. The processor can be configured to output the audio signal for the current displayed segment of said text.

The text display location can for example, consist of thirty (30) character entry points.

The processor can be coupled to a wireless transceiver for transmitting the passage of text over a cellular network. For example, the processor can transmit the passage of text as a short messaging service (SMS) text or as an email.

According to a further aspect of the present invention there is provided a vehicle interface system for performing word processing, the system comprising a processor configured to:
divide a passage of text into a plurality of segments each comprising one or more words, the segments each consisting of a maximum number of characters equal to or less than a fixed number of character entry points in a text display location; and
output a first of said segments to a display for display in said text display locations; and
convert the text in said first segment to an audio signal for audible output.

The processor can be configured to edit the text in said first segment based on voice commands from a user.

According to a yet further aspect of the present invention there is provided a vehicle incorporating a vehicle interface system as described herein.

According to a still further aspect of the present invention there is provided a method of operating a vehicle interface system to perform word processing, the method comprising:
dividing a passage of text into segments comprising one or more words, each segment consisting of a maximum number of characters equal to or less than a fixed number of said character entry points in a text display location; and
outputting each complete segment of said text to a display for display in the text display location.

The method can comprise generating the passage of text using speech recognition techniques. The passage can be dictated by a user and converted into text. The method can comprise receiving a voice signal corresponding to a dictated passage. The method can comprise transmitting the voice signal to a remote speech processing station (such as a remote server) to convert the voice signal into text data. The text data can be generated remotely at said remote speech processing station and transmitted to the vehicle interface system. The method can comprise receiving the text data at the vehicle interface system.

According to a further aspect of the present invention there is provided a computer program product for configuring or reconfiguring a vehicle system having a controller, the computer program product comprising a computer readable storage medium including computer readable program code, wherein the computer readable program code, when executed on the vehicle system, configures or reconfigures the vehicle system for performing a method as described herein.

The methods described herein can each be computer-implemented, for example on a computational apparatus comprising one or more microprocessors. According to a yet further aspect of the present invention there is provided a computer program product comprising a computer readable storage medium including computer readable program code, where the computer readable program code when executed on a computer causes the computer to perform the method(s) described herein.

The term processor used herein is to be understood as covering both single processors and multiple processors. For example, the processing steps described herein could be performed by a single processor; or could be performed by separate processors.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

An embodiment of the present invention will now be described, by way of example only, with reference to the accompanying Figures, in which:

FIG. 1 shows a schematic representation of a vehicle incorporating a vehicle interface system in accordance with an embodiment of the present invention;

FIG. 2 illustrates a display screen of the vehicle interface system in accordance with the present invention shown in FIG. 1; and

FIGS. 3A-3D illustrate a series of operations of the vehicle interface system 1 in accordance with the present invention.

### DETAILED DESCRIPTION OF AN EMBODIMENT

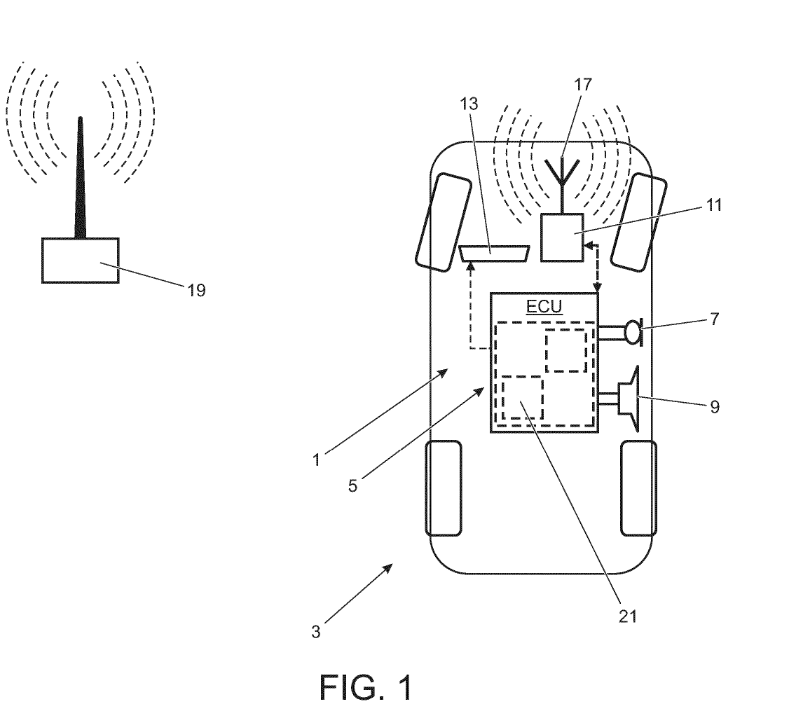

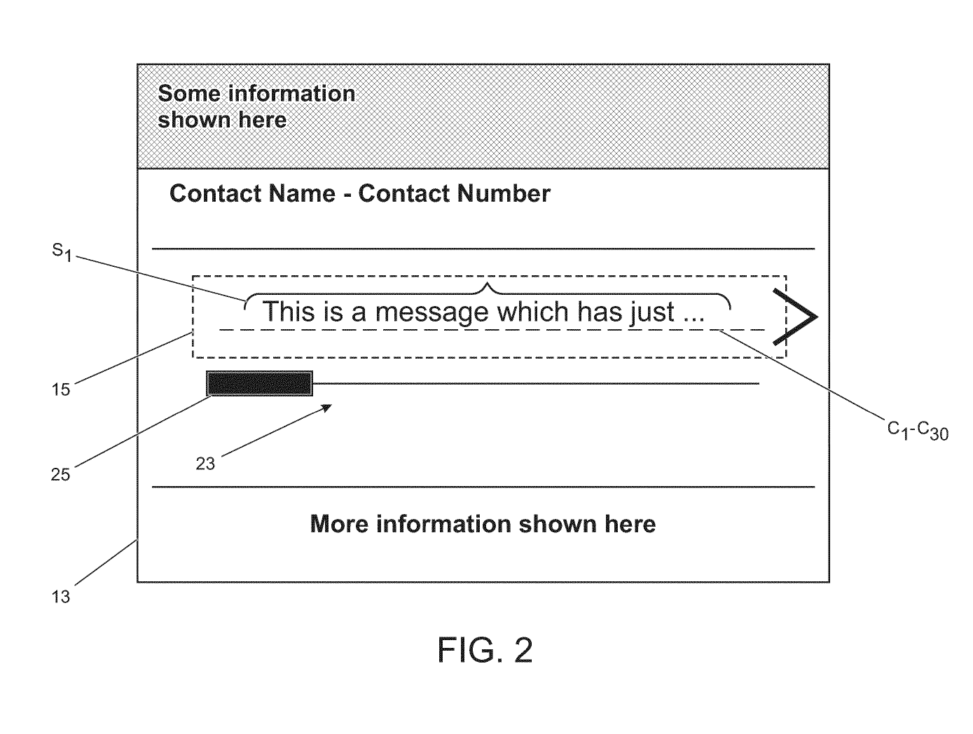

A vehicle interface system 1 for processing text in accordance with an embodiment of the present invention will now be described with reference to FIGS. 1 and 2. The vehicle interface system 1 is disposed in a vehicle 3 and is operative to enable a user to input, edit and delete text, for example to compose a short messaging service (SMS) text or an email.

The vehicle interface system 1 comprises a processing module 5 coupled to an on-board microphone 7 disposed in a cabin of the vehicle 3 to detect audio signals from within the cabin. The processing module 5 is also coupled to one or more loud speakers 9 disposed in the cabin to output audio signals, for example as part of an on-board audio entertainment system. The processing module 5 is in communication with a wireless transceiver 11 for transmitting and receiving signals over a cellular telecommunications network. As illustrated in FIG. 1, the transceiver 11 comprises an antenna 17.

A display screen 13 is provided in a central console (not shown) in the vehicle cabin. The display screen 13 can, for example, be a liquid crystal display (LCD). The display screen 13 can optionally comprise a touch screen for receiving user inputs. The display screen 13 can be operated in a variety of modes, for example to display an image from a parking assist camera or a satellite navigation map. However, the description herein will focus on the operation of the display screen 13 in a text processing mode in accordance with an embodiment of the present invention.

The processing module 5 is connected to the display screen 13 over a wired communications network (not shown), such as a CAN bus, within the vehicle 3. When operating in the aforementioned text processing mode, the display screen 13 is configured to display a text display location 15 in which text to be processed is displayed. The text display location 15 consists of a fixed number of character entry points C in which a character can be displayed. In the present embodiment, the text display location 15 consists of thirty (30) character entry points (C₁-C₃₀)_{,} thereby limiting the maximum length of text which can be displayed in the text display location 15 at any time to thirty (30) characters.

Speech recognition software is used to convert a dictated message into text data for output to the display screen 13. The processing module 5 in the present embodiment does not perform the speech recognition procedure. Rather, the processing module 5 communicates with a remote server 19 which is programmed to perform speech recognition. A suitable networked speech recognition system is provided by NUANCE of Massachusetts, 1 Wayside Road, Burlington, Mass. 01803, USA. The user dictates the message into the on-board microphone 7 and the processing module 5 transmits a voice signal representative of the dictation to the remote server 19 over the cellular telecommunications network. The remote server 19 performs analysis of the voice signal to generate text data corresponding to the message dictated by the user. The text data (comprising words and/or phrases) is then transmitted back to the processing module 5 over the cellular telecommunications network and is stored in a storage device 21. The text data typically forms a passage of text input by the user. The speech recognition can be performed substantially in real time over the network.

The processing module 5 is configured to divide the generated text into segments S₁-Sₙ, each segment S consisting of a maximum number of characters which is less than or equal to the fixed number of character entry points C in the text display location 15. In the present embodiment, the processing module 5 is configured to form each segment from thirty (30) characters rounded down to the nearest complete word. The segments are then output to the text display location 15 for review by the user. The segments are also read out to the user via Text-To-Speech (TTS) and the text displayed on screen changes in segmented chunks to display what is being read out.

A horizontal index 23 is displayed below the text display location 15 to provide a visual indication of the length of the passage of text. A marker 25 is overlaid on the index 23 to provide an indication of the position of the displayed segment within the passage of text.

The user can input voice commands, for example “INSERT”, “DELETE”, “REPLACE”, to edit the text displayed in the text display location 15. The identification of the voice commands could be performed locally (as a smaller vocabulary for instructions can reduce processing overheads).

When a voice command is issued, the vehicle interface system 1 will carry out the action without further prompts if the speech recognition confidence is high. If the confidence is low, a list of possible corrections is shown to the user for them to pick the correct option. By way of example, with reference to FIG. 2, if the user stated, ‘Replace message’ followed by ‘passage’, provided the recognition confidence is high, the word ‘message’ would be replaced with the word ‘passage’ and the sentence would be read out again. If the confidence in recognition of the word ‘passage’ was below a specified value, a list of candidate words would be shown for selection by the user. When a candidate word is selected from the list, the word would be inserted inline into the displayed segment and the sentence read out again. The introduction of a shorter or longer word into the segment may prompt the processing module 5 to recalculate the segments, for example if the amended segment exceeds 30 characters in length.

In order to implement changes to the remainder of the input text, the user can cycle through the different segments S of text stored in the storage device 21. The segments can each be displayed in full to enable the user to make any required changes. The user can progress forwards (i.e. towards the end of the passage of text) and optionally also backwards (i.e. towards the beginning of the passage of text) through the segments S sequentially.

The user can approve the input text once they are satisfied with the amendments and changes. The vehicle interface system 1 can then insert the completed text into an SMS text or an email in response to user requests.

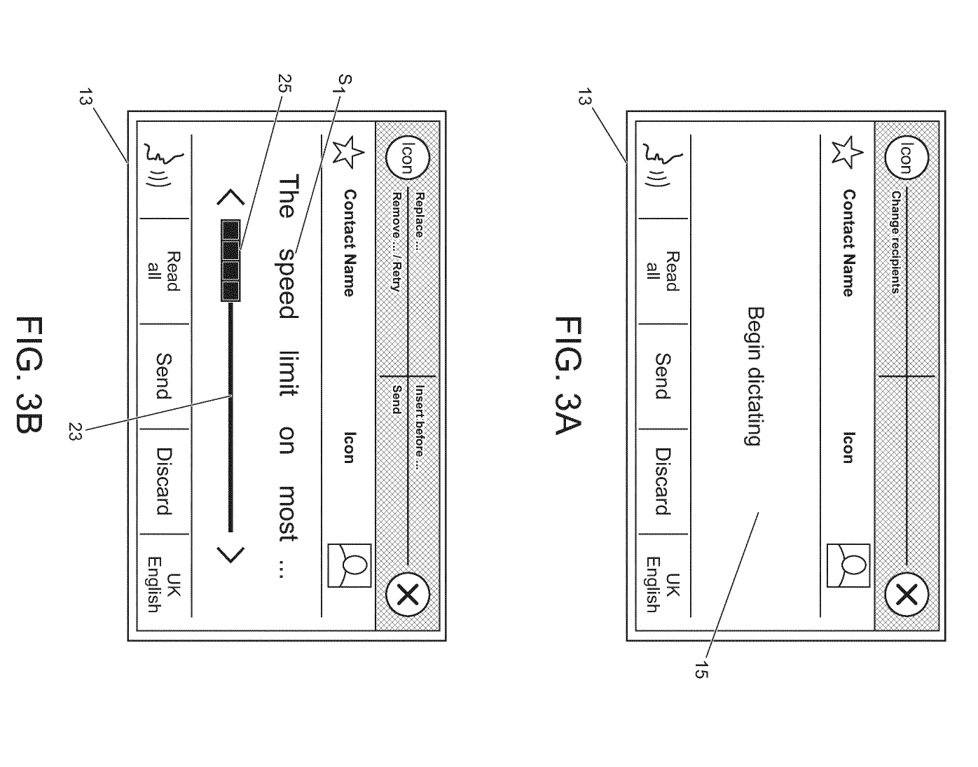

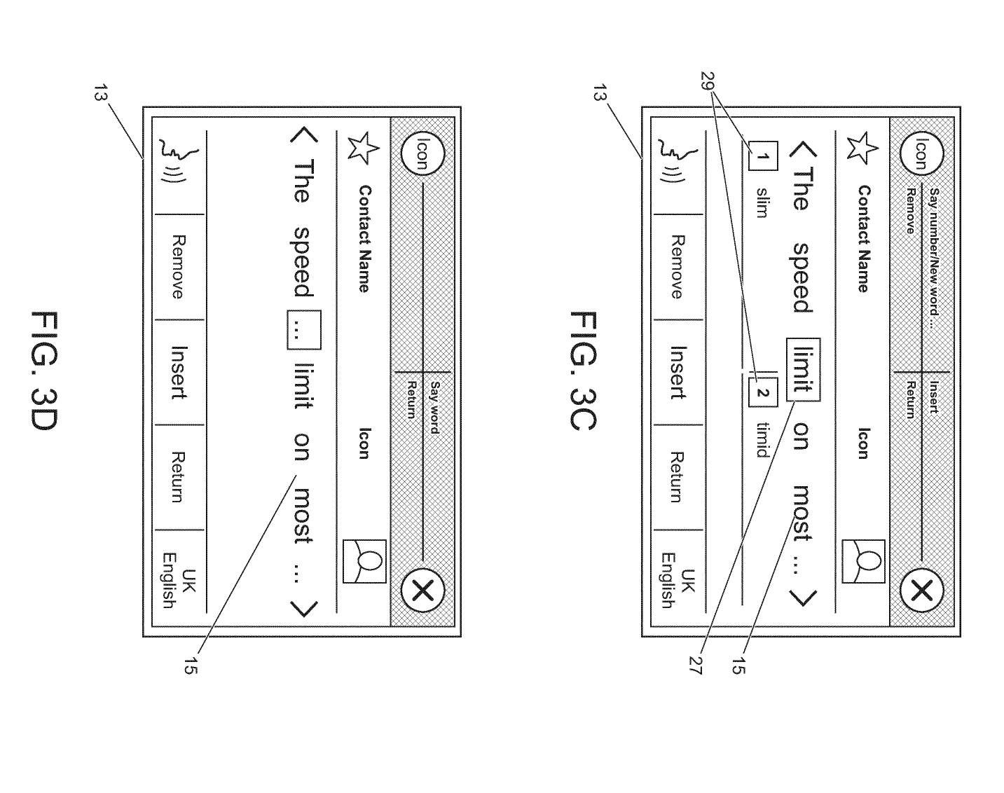

A worked example of a dictation session will now be described with reference to FIGS. 3A to 3D. A dictation is started by a user issuing an appropriate voice command, such as: “Send a message to <contact>” where <contact> is the name of contact name (which can be inserted automatically from a contacts database). The display screen 13 displays a text input screen comprising the text display location 15, as illustrated in FIG. 3A.

The vehicle interface system 1 then prompts the user to begin their dictation. As described herein, the dictated message is converted to a voice signal which is transmitted to the remote server 19 to perform speech recognition. The remote server 19 converts the voice signal to text data which is returned to the processing module 5 and stored in the storage device 21. In the present example, the user has dictated: “The speed limit on most motorways in Great Britain is seventy miles per hour period”.

The converted text is divided into segments S of up to 30 characters, rounded down to the nearest word by the processing module 5. If the converted text is longer than 30 characters, the text is divided across multiple segments. In the present example, the dictated text is divided into three (3) segments: (S₁) “The speed limit on most”; (S₂) “motorways in Great Britain is”; (S₃) “seventy miles per hour period”. The segments S₁-S₃ making up the longer message are each displayed in sequence in the text displayed location 15, as illustrated in FIG. 3B. The segment shown on the display will be read out using TTS and, when complete, the next segment will be shown and the TTS will continue without an audible gap.

If at any point the user interacts with the system in a way that is relevant to the dictation session, the TTS will pause and act on the interaction. If the interaction is a further dictation, this will be added to the end of the previously entered dictation and the TTS will resume from the start of the newly added dictation utterance.

As outlined above, the vehicle interaction system 1 allows the user to issue voice commands to perform a text processing functions. If the user wants to replace, insert or remove a word from the displayed segment, these actions can be performed via voice commands. To replace a word shown in the displayed segment, the user can issue the voice command “Replace <word>”. In the present example, the user issues the voice command “Replace limit” and the word “limit” is selected for replacement, as illustrated in FIG. 3C.

The vehicle interface system 1 provides a visual indication that the word ‘limit’ has been selected. In the present embodiment, a box 27 is overlaid on the text display location 15 to indicate the selected word. The words ‘slim’ and ‘timid’ are possible alternatives returned by the recognition engine and these are displayed in a first selection list 29 below the text display location 15. The user can select one of the candidate words by stating the corresponding number, for example “Select <1>” would select the replacement word “slim” in the present case. Rather than issue a voice command, the user could select the replacement word by contacting a touchscreen or other input means (such as a switch, a button or a jog wheel). The selected word is then introduced into the dictation passage to replace the original word ‘limit’ and the message is read out via TTS. If the entire message has previously been read out, then only the displayed segment will be read, otherwise the whole message will be read, starting from the segment displayed.

A similar method is used to insert words using the command: “Insert before <word>”. In the present example, issuing the voice command “Insert before limit” would result in the screen shown in FIG. 3D. From here, a new word can be dictated and will be inserted in to the segment. If the confidence for either the replacing word or the inserting word is high enough, these words will be entered directly into the dictation. If the confidence is too low, the words and any alternatives will be displayed on a list similar to that in FIG. 3C for the user to select by speech (or other input means).

To remove a word from the displayed segment the user can use the voice command: “Remove <word>”. This will remove the word from the segment and the TTS will follow the same rules as those described above in respect of FIG. 3C.

Under some circumstances a word that the user says as part of a voice command intended to edit the segment of text will appear more than once in the text. This causes uncertainty regarding the part of the text that the user wishes to edit, even if the system 1 determines a high recognition confidence for the word itself. To resolve this uncertainty the system may display a user-selectable option for each instance of the word, differentiating the individual instances from each other by including some of the text that immediately precedes or follows the word in each instance. Each user-selectable option may be numbered, so that the user may select the correct instance using a further voice command specifying the number of the instance that corresponds to the part of the text the user wishes to edit. Alternatively the user may select the required instance by other means, for example by contacting a touchscreen or other input means (such as a switch, a button or a jog wheel). Once the user has selected the desired instance the system performs the operation required by the original voice command on the selected instance of the word. Optionally, if the system determines a low recognition confidence for the word itself then further options corresponding to alternative words may also be displayed.

It should be noted that the probability of multiple instances of the same word occurring in a single displayed segment is reduced by selecting a relatively small maximum number of characters, for example thirty (30), for each segment. At any point after the initial dictation the user can use the voice command “Retry” or “Send”.

The voice command “Send” will send the message to the selected contact or contacts. The voice command “Retry” will remove the latest dictation and display either the screen shown in FIG. 3A if there are no previous dictations available or the last segment of the previous dictation entry if previous dictations are available.

At least in certain embodiments, the vehicle interface system 1 enables the input of a message by audio dictation coupled with audio feedback via the loud speakers 9. The display screen 13 provides limited visual feedback for the user via the text display location 15, thereby helping to reduce distraction as the message is input. Moreover, the audio dictation input and voice commands offer hands-free operation of the system so that a driver does not have to take their hands off the wheel whilst inputting a message.

It will be appreciated that various changes and modifications can be made to the vehicle interface system 1 described herein without departing from the scope of the present invention.

Further aspects of the present invention are set out in the following numbered paragraphs:
1. A vehicle interface apparatus for performing word processing, the apparatus comprising:
   a display for displaying text in the form of words made up of one or more characters, the display comprising a text display location consisting of a fixed number of character entry points;
   a processor configured to:
      divide a passage of text into segments comprising one or more words, each segment consisting of a maximum number of characters equal to or less than the fixed number of said character entry points; and
      output each complete segment of said text to the display for display in said text display location.
2. A vehicle interface apparatus as described in paragraph 1 comprising a wireless transmitter operative to transmit a voice signal to a remote speech processing station for conversion into text data corresponding to said passage of text; and a wireless transceiver operative to receive said text data from the remote processor.
3. A vehicle interface apparatus as described in paragraph 1 comprising a speech processing module for converting a voice signal into text data corresponding to said passage of text.
4. A vehicle interface apparatus as described in paragraph 1, wherein said processor is configured to form each segment from complete words.
5. A vehicle interface apparatus as described in paragraph 1, wherein said processor is configured to divide the passage of text into said segments as the text is input.
6. A vehicle interface apparatus as described in paragraph 1, wherein said processor is configured to divide the passage of text into said segments after the text has been input.
7. A vehicle interface apparatus as described in paragraph 6, wherein the processor is configured to output said segments to said display sequentially.
8. A vehicle interface apparatus as described in paragraph 7, wherein the processor is configured to perform editing of the text in the current displayed segment.
9. A vehicle interface apparatus as described in paragraph 8, wherein the processor is configured to perform editing of said text in response to one or more voice commands.
10. A vehicle interface apparatus as described in paragraph 1, wherein the processor is configured to convert the passage of text to an audio signal for output to a user.
11. A vehicle interface apparatus as described in paragraph 10, wherein the processor is configured to output said audio signal for the current displayed segment of said passage of text.
12. A vehicle interface apparatus as described in paragraph 1, wherein the text display location consists of thirty (30) character entry points.
13. A vehicle interface apparatus as described in paragraph 1, wherein the processor is coupled to a wireless transceiver for transmitting the passage of text over a cellular network.
14. A vehicle interface apparatus for performing word processing, the apparatus comprising a processor configured to:
   divide a passage of text into a plurality of segments each comprising one or more words, the segments each consisting of a maximum number of characters equal to or less than a fixed number of character entry points in a text display location; and
   output a first of said segments to a display for display in said text display locations; and
   convert the text in said first segment to an audio signal for audible output.
15. A vehicle interface apparatus as described in paragraph 14, wherein the processor is configured to edit the text in said first segment based on voice commands from a user.
16. A vehicle incorporating a vehicle interface apparatus as described in paragraph 1.
17. A vehicle incorporating a vehicle interface apparatus as described in paragraph 14.
18. A method of operating a vehicle interface apparatus to perform word processing, the method comprising:
   dividing a passage of text into segments comprising one or more words, each segment consisting of a maximum number of characters equal to or less than a fixed number of said character entry points in a text display location; and
   outputting each complete segment of said text to a display for display in the text display location.

1. A vehicle interface system, comprising:
a display configured to display text as words made up of one or more characters, the display comprising a text display location comprising of a fixed number of character entry points; and
a processor configured to:
divide a passage of text into segments comprising one or more words after the passage of text has been input, each segment comprising a maximum number of characters equal to or less than the fixed number of the character entry points;
sequentially output each complete segment of the passage of text to the display for display in the text display location, and
perform text editing of a current displayed segment in response to a voice command, wherein the text editing comprises:
carrying out a correction specified by the voice command if a confidence with which the voice command is identified is above a threshold value; and
displaying a list of possible corrections to a user and allowing the user to pick a correction if the confidence with which the voice command is identified is less than the threshold value.

2. The vehicle interface system of claim 1, further comprising a wireless transmitter operative to transmit a voice signal to a remote speech processor for conversion into text data corresponding to the passage of text, and a wireless transceiver operative to receive the text data from the remote speech processor.

3. The vehicle interface system of claim 1, further comprising a speech processing module configured to convert a voice signal into text data corresponding to the passage of text.

4. The vehicle interface system of claim 1, wherein the processor is configured to form each segment from complete words.

5. The vehicle interface system of claim 1, comprised in a vehicle.

6. The vehicle interface system of claim 1, wherein the processor is configured to convert the passage of text to an audio signal for output to the user.

7. The vehicle interface system of claim 6, wherein the processor is configured to output the audio signal for the current displayed segment of the passage of text.

8. The vehicle interface system of claim 1, wherein the fixed number of character entry points in the text display location is thirty (30) character entry points.

9. The vehicle interface system of of claim 1, wherein the processor is coupled to a wireless transceiver that is configured to transmit the passage of text over a cellular network.

10. A vehicle interface system for performing word processing, the system comprising a processor configured to:
divide a passage of text into a plurality of segments each comprising one or more words, the segments each comprising a maximum number of characters equal to or less than a fixed number of character entry points in a text display location;
display a first of the segments in the text display location;
convert text in the first segment to an audio signal for audible output; and
edit the text in the first segment based on voice commands from a user, wherein the editing of the text comprises:
carrying out a correction specified by a voice command if a confidence with which the voice command is identified is above a threshold value; and
displaying a list of possible corrections to the user and allowing the user to pick a correction if the confidence with which the voice command is identified is less than the threshold value.

11. (canceled)

12. A method of operating a vehicle interface system to perform word processing, the method comprising:
dividing a passage of text into segments comprising one or more words, wherein each segment comprises of a maximum number of characters equal to or less than a fixed number of character entry points in a text display location;
sequentially outputting each segment of the passage of text to a display for display in the text display location; and
editing text in a displayed segment in response to one or more voice commands from a user, wherein the editing of the text comprises:
carrying out a correction specified by a voice command if a confidence with which the voice command is identified is above a threshold value; and
displaying a list of possible corrections to the user and allowing the user to pick a correction if the confidence with which the voice command is identified is less than the threshold value.

13-14. (canceled)
